(19) United States
(12) Patent Application Publication
(10) Pub. No.: US 2024/0374472 A1
(43) Pub. Date: Nov. 14, 2024

(54) PISTON ASSEMBLY WITH A TRANSVERSELY REMOVABLE SUCTION CUP OR ADAPTER

(71) Applicant: PHYSIO-CONTROL, INC., Redmond, WA (US)

(72) Inventors: Marcus Ehrstedt, Kävlinge (SE); Thomas Falk, Staffanstorp (SE); Jonas Lagerstrom, Fagersanna (SE); Lars Anders Jörgen Segerstein, Staffanstorp (SE)

(73) Assignee: PHYSIO-CONTROL, INC., Redmond, WA (US)

(21) Appl. No.: 18/781,895

(22) Filed: Jul. 23, 2024

Related U.S. Application Data
(63) Continuation-in-part of application No. 17/510,266, filed on Oct. 25, 2021.
(63) Continuation-in-part of application No. 17/564,043, filed on Dec. 28, 2021.
Application No. 17/564,043 is a continuation-in-part of application No. 16/138,677, filed on Sep. 21, 2018, now Pat. No. 11,246,796.
Application No. 16/138,677 is a continuation-in-part of application No. 15/982,729, filed on May 17, 2018, now Pat. No. 11,020,312.
Application No. 15/982,729 is a continuation of application No. 14/573,995, filed on Dec. 17, 2014, now Pat. No. 10,004,662.
(60) Provisional application No. 63/105,683, filed on Oct. 26, 2020.
(60) Provisional application No. 62/009,109, filed on Jun. 6, 2014.
(60) Provisional application No. 63/184,687, filed on May 5, 2021.

(51) Int. Cl. A61H 31/00

(52) U.S. Cl. CPC A61H 31/007; A61H 31/005; A61H 31/006; A61H 2031/001; A61H 2201/0192; A61H 2201/123; A61H 2201/1246; A61H 2201/1619; A61H 2201/1623; A61H 2201/5058; A61H 2201/5061; A61H 2201/5064; A61H 2201/5069; A61H 2201/5092; A61H 2205/084

(57) ABSTRACT

A piston assembly with a transversely removable suction cup, the piston assembly having a piston rod, a flange at an end of the piston rod, and a suction cup removably secured to the end of the piston rod. The piston rod has a longitudinal axis defining a longitudinal direction and a transverse direction that is substantially perpendicular to the longitudinal direction. The flange has a width in the transverse direction that is greater than a width of the piston rod in the transverse direction. The suction cup includes a receptacle configured to accept and secure the flange within the receptacle. The receptacle has an opening allowing the flange to be accepted into the receptacle in the transverse direction and to be removed from the receptacle in the transverse direction.

### CROSS-REFERENCES TO RELATED APPLICATIONS

This patent application is a continuation-in-part of U.S. patent application Ser. No. 17/510,266, filed Oct. 25, 2021, which claims the benefit of U.S. Provisional Patent Application No. 63/105,683, filed Oct. 26, 2020, the disclosures of both of which are incorporated herein by reference in their entirety.

This application is also a continuation-in-part of U.S. patent application Ser. No. 17/564,043, filed Dec. 28, 2021, which claims the benefit of U.S. Provisional Patent Application No. 63/184,687, filed May 5, 2021, and which is a continuation in-part of U.S. patent application Ser. No. 16/138,677, filed Sep. 21, 2018, and granted on Feb. 15, 2022 as U.S. Pat. No. 11,246,796, which is a continuation-in-part of U.S. patent application Ser. No. 15/982,729, filed May 17, 2018, and granted on Jun. 1, 2021 as U.S. Pat. No. 11,020,312, which is a continuation of U.S. patent application Ser. No. 14/573,995, filed Dec. 17, 2014, and granted on Jun. 26, 2018 as U.S. Pat. No. 10,004,662, which claims the benefit of U.S. Provisional Patent Application No. 62/009,109, filed Jun. 6, 2014, the disclosures of all of which are incorporated herein by reference in their entirety.

### TECHNICAL FIELD

This disclosure is directed to systems and methods related to pistons having suction cups. In particular, this disclosure is directed to systems and methods related to mechanical cardiopulmonary resuscitation (CPR) devices having pistons with suction cups.

### BACKGROUND

Mechanical compression devices for CPR are being increasingly adopted by emergency medical services around the world. Traditionally, CPR has been performed manually by a rescuer. However, during longer duration resuscitations, a rescuer can become fatigued and provide inadequate compressions. Mechanical compression devices have been adopted by many emergency medical services to address these potential drawbacks of manual CPR by a rescuer.

Configurations of the disclosed technology address shortcomings in the prior art.

### BRIEF DESCRIPTION OF THE DRAWINGS

Aspects, features and advantages of examples of the present disclosure will become apparent from the following description of examples in reference to the appended drawings in which:

FIG. 1 is a front view of a mechanical compression device with an adjustment mechanism to adjust a compression position according to some examples of the disclosure.

FIG. 2 is a partially exploded, perspective view of a portion of a piston and a suction cup, according to an example configuration.

FIG. 3 is an unexploded, perspective view of a portion of the piston and the suction cup of FIG. 2.

FIG. 4 depicts a perspective view of a piston adapter, according to an example aspect of the present disclosure.

FIG. 5 depicts a side view of the piston adapter of FIG. 4.

FIG. 6 depicts a top view of the piston adapter of FIG. 4.

FIG. 7 depicts a bottom view of the piston adapter of FIG. 4.

FIG. 8 depicts a perspective view of a mechanical CPR device including the piston adapter of FIG. 4, in accordance with an example configuration of the present disclosure.

FIG. 9 depicts a perspective view of the piston adapter of FIG. 4 and a suction cup, the piston adapter being in an example of a locked position.

FIG. 10 depicts the piston adapter of FIG. 4 in an example of an unlocked position.

### DETAILED DESCRIPTION

Examples presented in this disclosure are directed to systems having pistons with suction cups. Some configurations have a particular application to mechanical cardiopulmonary resuscitation (CPR) devices.

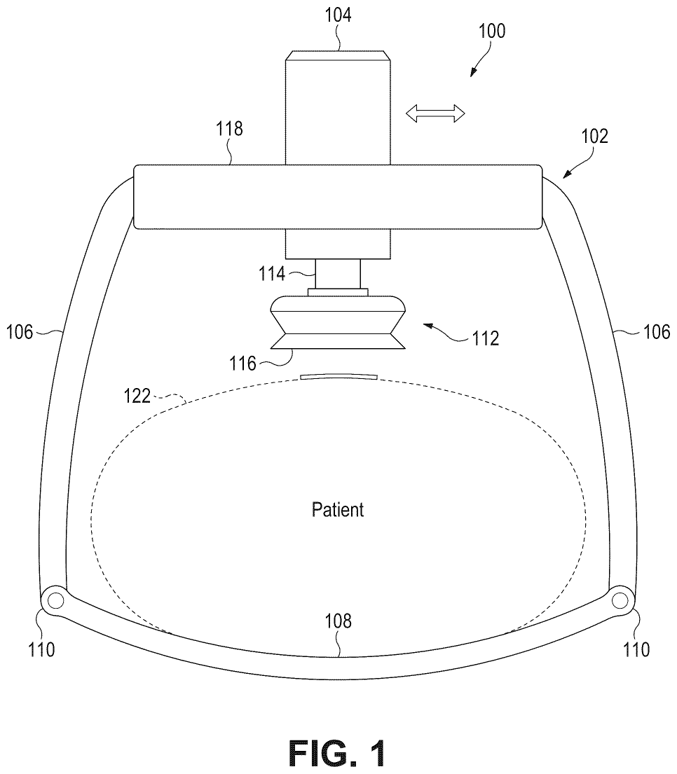

FIG. 1 is a front view of an example mechanical CPR device 100 that can compress and/or expand a chest and/or abdomen of a patient 122. As will be understood by one skilled in the art, the mechanical CPR device 100 may include additional components not shown in FIG. 1.

As illustrated in FIG. 1, a CPR device 100 may include a support structure 102 and a central unit 104. The support structure 102 may include support legs 106 and a base member 108. The support legs 106 and the base member 108 meet at a junction 110 between each support leg 106 and the base member 108.

The support legs 106 may be configured to support the central unit 104 at a distance from the base member 108. For example, if the base member 108 is underneath the patient, who is lying on the patient's back, then the support legs 106 may support the central unit 104 at a sufficient distance over the base member 108 to allow the patient to lay within a space between the base member 108 and the central unit 104, while positioning a compression mechanism 112 over the patient's chest or abdomen. The base member 108 may be configured to be placed underneath the patient's back or shoulders when the patient is lying on the patient's back.

The central unit 104 may be configured to deliver CPR compressions to the patient. The central unit 104 may include, for example, a compression mechanism 112 that has a rod, or motor-driven piston 114, configured to contact the patient's chest through a suction cup 116 or other interface to provide CPR compressions. The central unit 104 may also include a number of electronic components to drive the motor-driven piston 114. In the example illustrated in FIG. 1, attached to the motor-driven piston 114 is a suction cup 116 that adheres to the chest of the patient during chest compressions. The suction cup 116 can allow the motor-driven piston 116 to lift the chest back to a resting height, or provide a full decompression of the chest of the patient, when the motor-driven piston 116 is retracted from an extended position.

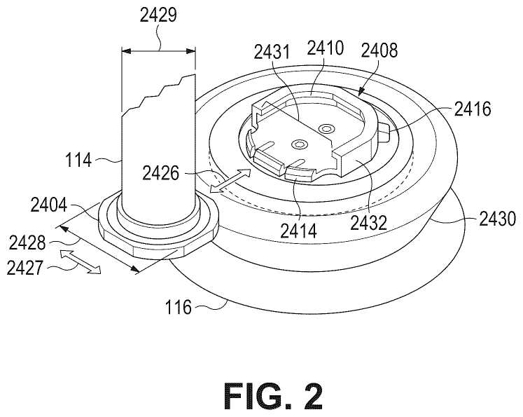

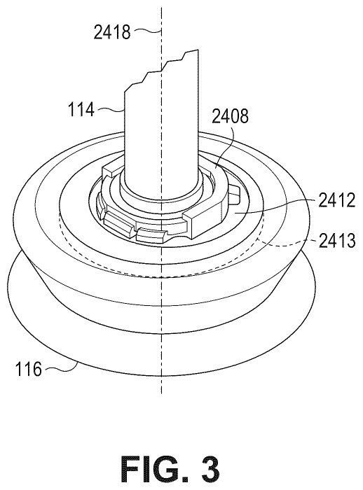

FIG. 2 is a partially exploded, perspective view of a portion of a piston and a suction cup, according to an example configuration. FIG. 3 is an unexploded, perspective view of the portion of the piston and the suction cup of FIG. 2.

As illustrated in FIGS. 2 and 3, an end 2404 of the motor-driven piston 114 couples to a bracket 2408 affixed to the suction cup 116. The rod end 2404 may be flanged, such as, for example, as illustrated in FIG. 2. In configurations, the end 2404 may slide under a lip or edge 2410 of the bracket 2408 to secure the end 2404 within the bracket 2408. The bracket 2408 may include one or more tabs 2414 configured to secure the end 2404 of the motor-driven piston 114 under the lip or edge 2410 of the bracket 2408. In configurations, the bracket 2408 may include an adjustment knob 2416 to assist in removing the end 2404 of the motor-driven piston 114 from the bracket 2408 by, for example, mechanically pushing the end 2404 out from under the lip or edge 2410 of the bracket 2408.

Arrow 2426 in FIG. 2 shows an example of a first transverse direction that is substantially perpendicular to a longitudinal direction that is defined by the centerline, or longitudinal axis, 2418 of the piston 114. As used in this context, “substantially perpendicular” means largely or essentially at right angles, without requiring perfect perpendicularity. Arrow 2427 in FIG. 2 shows an example of a second transverse direction that is substantially perpendicular to the longitudinal direction 2418 and to the first transverse direction 2426. The convention used in this disclosure is that the first transverse direction 2426 means the direction that the bracket 2408 moves, relative to the flanged end 2404 of the piston 114, to insert the flanged end 2404 of the piston 114 within the bracket 2408 or to remove the flanged end 2404 of the piston 114 from the bracket 2408. In the illustrated configuration, there is one first transverse direction, designated by the double-ended arrow 2426 in FIG. 2. In other configurations, there may be more than one first transverse direction, meaning more than one direction that the bracket 2408 could move, relative to the flanged end 2404 of the piston 114, to insert the flanged end 2404 of the piston 114 within the bracket 2408 or to remove the flanged end 2404 of the piston 114 from the bracket 2408.

The flange 2404 has a width 2428 in the second transverse direction 2427 that is greater than a width 2429 of the piston rod 114 in the second transverse direction 2427.

The suction cup 116 may include a main body portion 2430 of the suction cup 116 and a receptacle, such as the bracket 2408, that is configured to accept and secure the flanged end 2404 of the piston 114 within the receptacle 2408. As illustrated, in configurations the rotational axis of symmetry of the main body portion 2430 of the suction cup 116 coincides with the longitudinal axis 2418 of the piston 114. In configurations, the receptable 2408 may be rigidly affixed to or lodged within the main body portion 2432 of the suction cup 116, such as with an interference fit or otherwise embedding the receptable 2408 within the main body portion 2432. The receptacle 2408 has an opening 2431 that allows the flanged end 2404 to be accepted into the receptacle 2408 in the first transverse direction 2426 and to be removed from the receptacle in the first transverse direction 2426. In configurations, the opening 2431 of the receptacle 2408 substantially prevents acceptance of the flange 2404 into the receptacle 2408 in the longitudinal direction 2418 and removal of the flanged end 2404 from the receptacle 2408 in the longitudinal direction 2418. As used in this context, “substantially prevent” means largely or essentially hindering, without requiring perfect avoidance of all occurrences such as, for example, if a user were to force the flange 2404 in the longitudinal direction 2418 outside the bounds of normal use. This prevention of acceptance of the flange 2404 into the receptacle 2408 in the longitudinal direction 2418 and removal of the flanged end 2404 from the receptacle 2408 in the longitudinal direction 2418 may be accomplished by, for example, tabs, sidewalls, or other obstructions 2432 that constrain motion of the flanged end 2404 of the piston 114. In configurations, such tabs, sidewalls, or other obstructions 2432 might include an extended lip or edge 2410 to further constrain motion of the flanged end 2404.

In configurations, the opening 2431 of the receptacle 2408 substantially prevents acceptance of the flange 2404 into the receptacle 2408 in a transverse direction (perpendicular to the longitudinal direction 2418) that is not the first transverse direction indicated by the arrow 2426 in FIG. 2. As noted, the first transverse direction longitudinal direction that is defined by the centerline, or longitudinal axis, 2426 is the direction in which the receptacle 2408 is configured to accept the flange 2404 via the opening 2431 of the receptacle 2408. In such configurations, portions of the receptacle 2408 that form the opening 2431 may also substantially prevent removal of the flanged end 2404 from the receptacle 2408 in a transverse direction that is not the first transverse direction 2426. For example, as illustrated in FIG. 2, tabs, sidewalls, or other obstructions 2432 may constrain motion of the flanged end 2404 of the piston 114 to allow insertion into and removal of the flange 2404 from the receptacle 2408 in the first transverse direction 2426 but not in any other transverse direction, including not in the second transverse direction 2427.

As discussed above, the flange 2404 has a width 2428 in the second transverse direction 2427 that is greater than the width 2429 of the piston rod 114 in the transverse direction 2427.

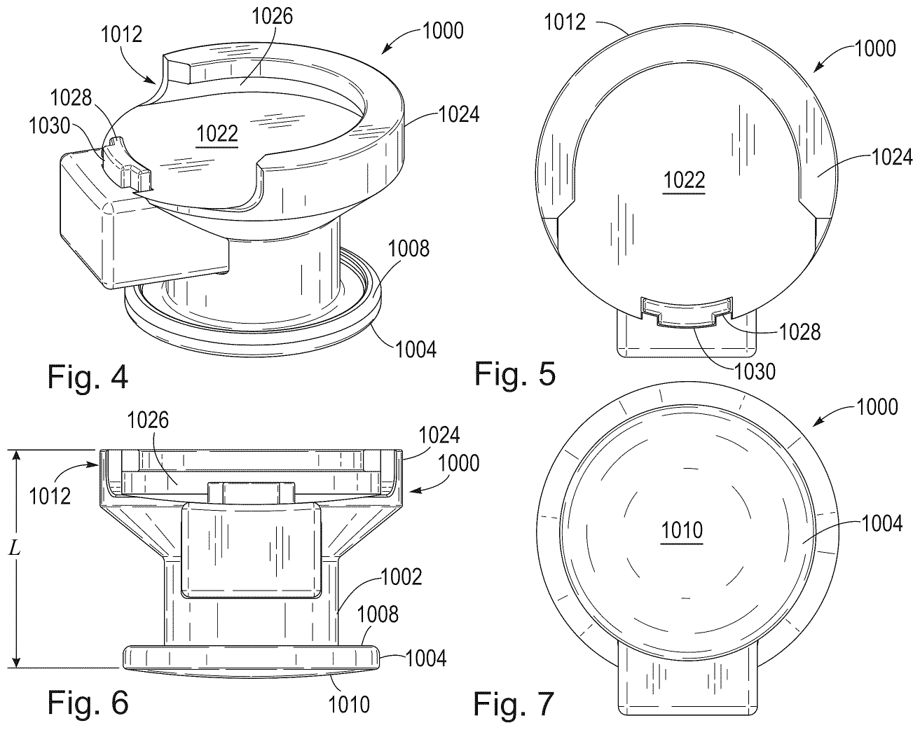

FIGS. 4-10 depict an example configuration of a piston adapter 1000 configured to be installed between the piston end 1016 and a suction cup 1006. The piston adapter 1000 includes a body 1002 having a suction cup attachment surface 1004 for removable attachment to a suction cup 1006. The suction cup attachment surface 1004 can include a circumferential adapter flange 1008 and/or a substantially flat surface 1010. A piston connection surface 1012 is disposed opposite the suction cup attachment surface 1004. The piston connection surface 1012 is configured to releasably engage with a piston surface 1014, for example a piston end 1016. The piston surface 1014 may have substantially the same configuration as the suction cup attachment surface 1004. For example, the piston surface 1014 includes a circumferential piston flange 1018 and/or a substantially flat surface 1020 disposed at the piston end 1016.

The piston connection surface 1012 includes a base 1022 and a lip 1024 extending above the base 1022 having a lip recess 1026. The lip 1024 and/or the lip recess 1026 are configured to partially encircle the piston flange 1018. The piston connection surface 1012 further includes at least one engagement member 1028 disposed on the base 1022 configured to releasably engage the piston surface 1014. The engagement member 1028 may be disposed opposite the lip 1024.

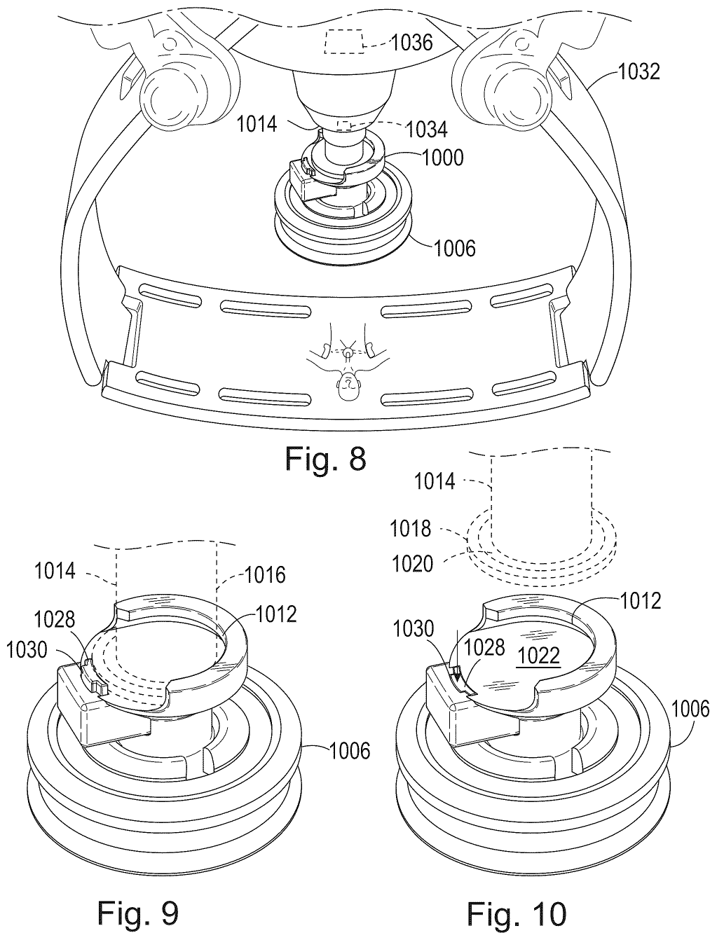

The piston adapter 1000 has a locked position, as shown in FIGS. 8 and 9, and an unlocked position, as shown in FIG. 10. In the locked position, the engagement member 1028 protrudes above the base 1022 to releasably engage the circumferential piston flange 1018 disposed on the base 1022 and partially encircled by the lip 1024 and/or the lip recess 1026. In other words, in the locked position the engagement member 1028 prevents the piston surface 1014 from sliding out of the lip recess 1026 and/or disengaging from the piston connection surface 1012. The engagement member 1028 is moveable from the locked position (FIG. 9) to the unlocked position (FIG. 10). In the unlocked position, the engagement member 1028 is retracted such that it is substantially flush with the base 1022. In the unlocked position, the engagement member 1028 is no longer engaged with the circumferential piston flange 1018 and allows disengagement of the circumferential piston flange 1018 from the lip recess 1026 and/or disengagement of the piston surface 1014 from the piston connection surface 1012. The piston adapter 1000 may be biased via a spring or other biasing means to the locked position.

The piston adapter 1000 may additionally and/or alternatively include a release member 1030 that when activated allows disengagement of the piston connection surface 1012 from the piston surface 1014. For example, activation of the release member 1030 may move the engagement member 1028 from the locked position to the unlocked position. See the directional arrow in FIG. 10. The release member 1030 can be attached to the engagement member 1028 such that depression or movement of the release member 1030 also depresses or moves the engagement member 1028. As shown in FIGS. 8 and 9, in the locked position the release member 1030 protrudes above the base 1022. As shown in FIG. 10, in the unlocked position the release member 1030 is pushed or retracted towards the suction cup attachment surface 1004 such that the release member 1030 is substantially flush with the base 1022.

The piston adapter 1000 has a piston adapter length L extending from the piston engagement portion 1012, such as the base 1022, to the suction cup engagement portion 1004. FIG. 8 depicts a mechanical CPR device 1032 including the piston adapter 1000, in accordance with the present disclosure. The piston adapter length is added to the length of piston, so that the piston and piston adapter may extend to engage a smaller patient's torso (not shown). In some embodiments, the CPR device 1032 may include a piston sensor 1034 configured to detect engagement of the piston surface 1014 with the piston connection surface 1012. The piston sensor 1032 may be configured to send a signal to a controller 1036 when engagement of the piston surface 1014 with the piston connection surface 1012 is detected. In this way, by extending the piston via the piston adapter, the piston's reference point may be set correctly to accommodate a patient having a smaller sternum. By adjusting the reference point of the piston/suction cup, the movement of the piston may be recalibrated to correctly and safely perform mechanical CPR on a patient (not shown).

For purposes of this description, certain aspects, advantages, and novel features of the examples of this disclosure are described herein. Features, integers, characteristics, compounds, chemical moieties or groups described in conjunction with a particular aspect, configuration, or example of the disclosure are to be understood to be applicable to any other aspect, configuration or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing examples. The disclosure extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. “Generally” or “approximately” as used herein means a variance of 10%.

As used herein, the term “and/or” used between the last two of a list of elements means any one or more of the listed elements. For example, the phrase “A, B, and/or C” means “A,” “B,” “C,” “A and B,” “A and C,” “B and C,” or “A, B, and C.”

As used herein, the term “coupled” generally means physically coupled or linked and does not exclude the presence of intermediate elements between the coupled items absent specific contrary language.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the disclosure have been illustrated and described for purposes of illustration, it will be understood that various modifications may be made without departing from the spirit and scope of the disclosure.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the described apparatus may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

I (or we) claim:

1. A piston assembly with a transversely removable suction cup, the piston assembly comprising:
a piston rod having a longitudinal axis defining a longitudinal direction and a transverse direction that is substantially perpendicular to the longitudinal direction;
a flange at an end of the piston rod, the flange having a width in the transverse direction that is greater than a width of the piston rod in the transverse direction; and
a suction cup removably secured to the end of the piston rod, the suction cup including a receptacle configured to accept and secure the flange within the receptacle, the receptacle having an opening allowing the flange to be accepted into the receptacle in the transverse direction and to be removed from the receptacle in the transverse direction.

2. The piston assembly of claim 1, the opening of the receptacle further includes one or more obstructions to substantially prevent acceptance of the flange into the receptacle in the longitudinal direction and removal of the flange from the receptacle in the longitudinal direction.

3. The piston assembly of claim 1, in which the receptacle further includes a lip to substantially prevent acceptance of the flange into the receptacle in the longitudinal direction and removal of the flange from the receptacle in the longitudinal direction.

4. The piston assembly of claim 3, in which the receptacle further includes a tab to secure the flange under the lip of the receptacle.

5. The piston assembly of claim 3, in which the receptacle further includes a knob configured to push the flange out from under the lip of the receptacle.

6. A suction cup that is transversely removable from and mountable to a rod, the suction cup comprising:
a rotational axis of symmetry defining a longitudinal direction and a transverse direction that is substantially perpendicular to the longitudinal direction; and
a receptacle configured to accept and secure a rod end within the receptacle, the receptacle having an opening allowing the rod end to be accepted into the receptacle in the transverse direction and to be removed from the receptacle in the transverse direction.

7. The suction cup of claim 6, the opening of the receptacle further substantially preventing acceptance of the rod end into the receptacle in the longitudinal direction and removal of the flange from the receptacle in the longitudinal direction.

8. The suction cup of claim 6, in which the receptacle further includes a lip to substantially prevent acceptance of the rod end into the receptacle in the longitudinal direction and removal of the rod end from the receptacle in the longitudinal direction.

9. The suction cup of claim 8, in which the receptacle further includes a tab to secure the rod end under the lip of the receptacle.

10. The suction cup of claim 8, in which the receptacle further includes a knob configured to push the rod end out from under the lip of the receptacle.

11. A mechanical cardiopulmonary resuscitation (CPR) device comprising:
a motor-driven piston having a longitudinal axis defining a longitudinal direction and a transverse direction that is substantially perpendicular to the longitudinal direction;
a flange at an end of the motor-driven piston, the flange having a width in the transverse direction that is greater than a width of the motor-driven piston in the transverse direction; and
a suction cup removably secured to the end of the motor-driven piston, the suction cup including a bracket configured to accept and secure the flange within the bracket, the bracket having an opening allowing the flange to be accepted into the bracket in the transverse direction and to be removed from the bracket in the transverse direction.

12. The mechanical CPR device of claim 11, the opening of the bracket further substantially preventing acceptance of the flange into the bracket in the longitudinal direction and removal of the flange from the bracket in the longitudinal direction.

13. The mechanical CPR device of claim 11, in which the bracket further includes a lip to substantially prevent acceptance of the flange into the bracket in the longitudinal direction and removal of the flange from the bracket in the longitudinal direction.

14. The mechanical CPR device of claim 13, in which the bracket further includes a tab to secure the flange under the lip of the bracket.

15. The mechanical CPR device of claim 13, in which the bracket further includes a knob configured to push the flange out from under the lip of the bracket.

16. The mechanical CPR device of claim 11, further comprising:
a motor configured to deliver cardiopulmonary resuscitation (CPR) compressions to a patient's chest;
a base member configured to be placed underneath a patient's back or shoulders when a patient is lying on the patient's back; and
support legs configured to support the motor at a distance from the base member and over the patient's chest.

17. A piston assembly with a transversely removable adapter, the piston assembly comprising:
a piston rod having a longitudinal axis defining a longitudinal direction and a transverse direction that is substantially perpendicular to the longitudinal direction;
a flange at an end of the piston rod, the flange having a width in the transverse direction that is greater than a width of the piston rod in the transverse direction; and
an adapter removably secured to the end of the piston rod, the adapter including a receptacle configured to accept and secure the flange within the receptacle, the receptacle having an opening allowing the flange to be accepted into the receptacle in the transverse direction and to be removed from the receptacle in the transverse direction, the adapter configured to be installed between the piston rod and a suction cup.

18. The piston assembly of claim 17, the opening of the receptacle further includes one or more obstructions to substantially prevent acceptance of the flange into the receptacle in the longitudinal direction and removal of the flange from the receptacle in the longitudinal direction.

19. The piston assembly of claim 17, in which the receptacle further includes a lip to substantially prevent acceptance of the flange into the receptacle in the longitudinal direction and removal of the flange from the receptacle in the longitudinal direction.

20. The piston assembly of claim 19, in which the receptacle further includes a tab to secure the flange under the lip of the receptacle.

21. A mechanical cardiopulmonary resuscitation (CPR) device comprising:
a motor-driven piston having a longitudinal axis defining a longitudinal direction and a transverse direction that is substantially perpendicular to the longitudinal direction;
a flange at an end of the motor-driven piston, the flange having a width in the transverse direction that is greater than a width of the motor-driven piston in the transverse direction; and
an adapter removably secured to the end of the motor-driven piston, the adapter including a bracket configured to accept and secure the flange within the bracket, the bracket having an opening allowing the flange to be accepted into the bracket in the transverse direction and to be removed from the bracket in the transverse direction.

22. The mechanical CPR device of claim 21, the opening of the bracket further substantially preventing acceptance of the flange into the bracket in the longitudinal direction and removal of the flange from the bracket in the longitudinal direction.

23. The mechanical CPR device of claim 21, in which the bracket further includes a lip to substantially prevent acceptance of the flange into the bracket in the longitudinal direction and removal of the flange from the bracket in the longitudinal direction.

24. The mechanical CPR device of claim 23, in which the bracket further includes a tab to secure the flange under the lip of the bracket.

25. The mechanical CPR device of claim 21, further comprising:
a suction cup coupled to the adapter at an end of the adapter opposite to where adapter is removably secured to the end of the motor-driven piston;
a motor configured to deliver cardiopulmonary resuscitation (CPR) compressions to a patient's chest;
a base member configured to be placed underneath a patient's back or shoulders when a patient is lying on the patient's back; and
support legs configured to support the motor at a distance from the base member and over the patient's chest.
